(19) United States
(12) Patent Application Publication
(10) Pub. No.: US 2014/0365826 A1
(43) Pub. Date: Dec. 11, 2014

(54) AUTOMATIC TESTING METHOD AND SYSTEM FOR ELECTRONIC DEVICES

(71) Applicants: HON HAI PRECISION INDUSTRY CO., LTD., New Taipei (TW); HONG FU JIN PRECISION INDUSTRY (ShenZhen) CO., LTD., ShenZhen (CN)

(72) Inventor: QING-HUA LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., ShenZhen (CN)

(21) Appl. No.: 14/137,282

(22) Filed: Dec. 20, 2013

(30) Foreign Application Priority Data
Jun. 7, 2013 (CN) 2013102259887

(51) Int. Cl. G06F 11/263

(52) U.S. Cl. CPC G06F 11/263
USPC 714/27

(57) ABSTRACT

An automatically testing system includes a control device and a testing instrument. The control device initializes a first Input/Output (I/O) interface, and the testing instrument initializes a second I/O interface and a third I/O interface. The testing instrument receives test parameters of an electronic device to generate test data and transmits the test data to the control device. The control device receives the test data and transmits the test data to a data analyzing unit. The data analyzing unit analyzes the test data and determines whether the test data are valid. The data analyzing unit transmits the test data which are determined to be valid to a test result display unit to display the test data. The data analyzing unit stores the test data which are determined to be valid in a data storage unit, and the control device determines whether the testing instrument has completed testing the electronic device.

### BACKGROUND

1. Technical Field

The present disclosure relates to a method and system for automatically testing electronic devices.

2. Description of Related Art

Electronic devices need to be tested by testing instruments after being manufactured. However, known testing instruments are semi-automatic, and test results are manually recorded by an operator. Thus, testing and recording of the test results are laborious and time-consuming.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a system for automatically testing an electronic device, wherein the system includes a control device and a testing instrument.

FIG. 2 is a block diagram of an embodiment of the control device of FIG. 1.

FIG. 3 is a flowchart of an embodiment of a method for automatically testing an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blue-Ray discs, Flash memory, and hard disk drives.

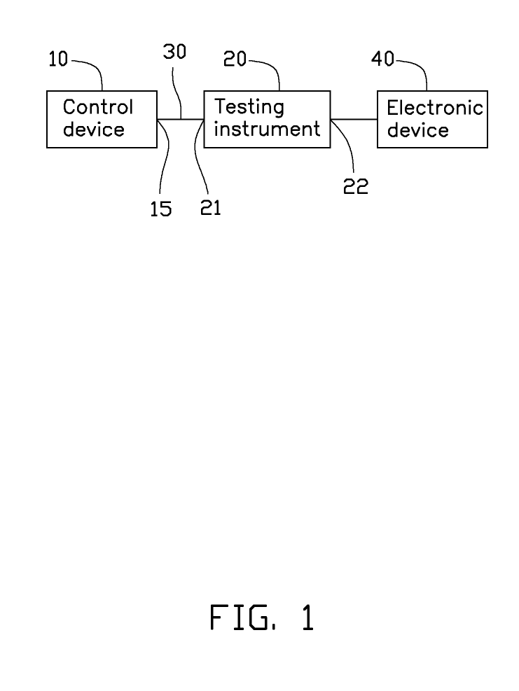

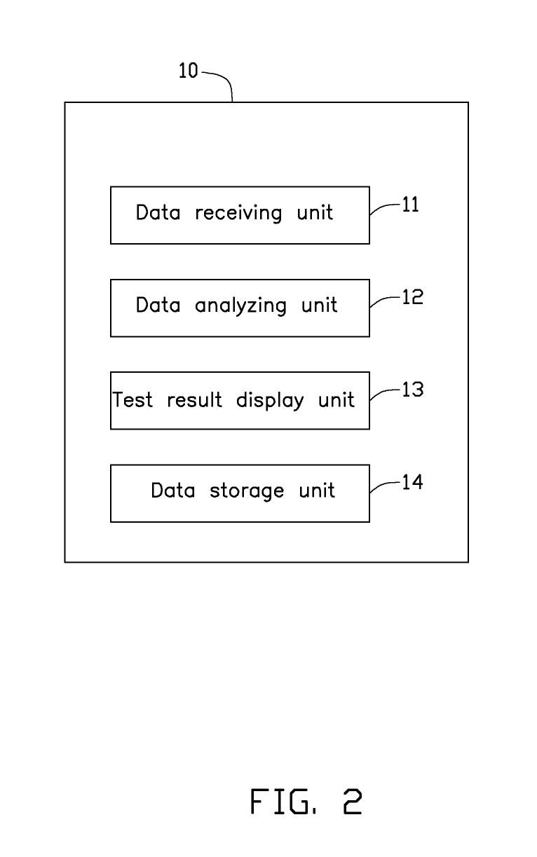

FIGS. 1 and 2 show an embodiment of a system for automatically testing an electronic device 40. The system includes a control device 10, a testing instrument 20, and a transforming line 30 electrically connected between the control device 10 and the testing instrument 20. The control device 10 can be a host computer, a server computer, a tablet computer, or the like.

The control device 10 includes a data receiving unit 11, a data analyzing unit 12, a test result display unit 13, a data storage unit 14, and a first Input/Output (I/O) interface 15.

The testing instrument 20 includes a second I/O interface 21 and a third I/O interface 22. The first I/O interface 15 of the control device 10 is electrically connected to the second I/O interface 21 of the testing instrument 20 via the transforming line 30. The third I/O interface 22 of the testing instrument 20 is electrically connected to the electronic device 40. The transforming line 30 is configured for transforming and transferring data between the first I/O interface 15 and the second I/O interface 21. In one embodiment, the first I/O interface 15 is a Universal Serial Bus (USB) port, and the second I/O interface 21 and the third I/O interface 22 are Digital Visual Interface (DVI) ports.

The testing instrument 20 receives test parameters of the electronic device 40 through the third I/O interface 22. The testing instrument 20 is configured for testing the electronic device 40 to generate test data. The testing instrument 20 transmits the test data to the control device 10 through the second I/O interface 21.

The control device 10 receives the test data through the data receiving unit 11, and transmits the test data to the data analyzing unit 12. The data analyzing unit 12 is configured for analyzing the test data and determining whether the test data are valid. The data storage unit 14 stores multiple predetermined test data. The data analyzing unit 12 is configured for comparing the test data with the multiple predetermined test data and determining whether the test data are valid. If the test data are within a range of the multiple predetermined test data, the test data are valid. If the test data are not within the range of the multiple predetermined test data, the test data are invalid.

The data analyzing unit 12 transmits the test data which are determined to be valid to the test result display unit 13, and the test result display unit 13 displays the test data transmitted by the data analyzing unit 12. The data analyzing unit 12 transmits and stores the test data which are determined to be valid in the data storage unit 14. The test data displayed on the test result display unit 13 are checked by an operator to determine whether the electronic device 40 passes the test.

The system is not limited to test one electronic device 40 by one testing instrument 20. Multiple testing instruments 20 can be connected to the system for testing multiple electronic devices 40. The multiple testing instruments 20 can be connected to one or more control devices 10.

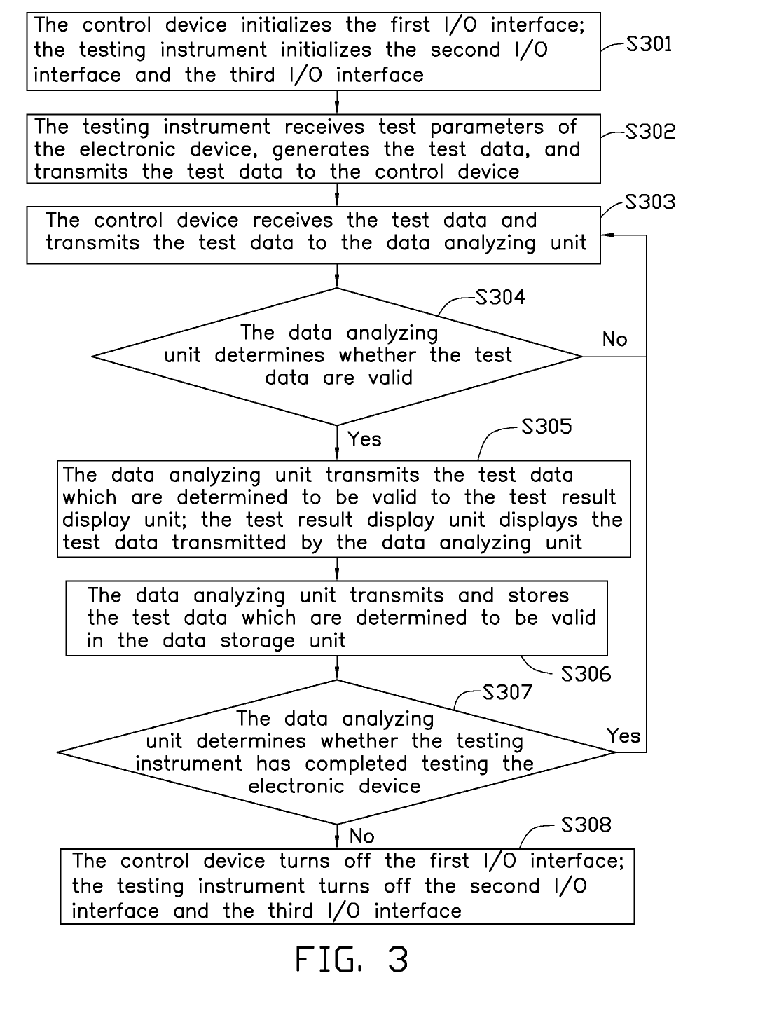

FIG. 3 shows a flow chart of an embodiment of a method for automatically testing the electronic device 40. Depending on the embodiment, certain steps described below may be removed, while others may be added, and the sequence of the steps may be altered. In one embodiment, the method for testing a working voltage of a CPU utilizing the above-described system includes the following steps:

S301: the control device 10 initializes the first I/O interface 15; the testing instrument 20 initializes the second I/O interface 21 and the third I/O interface 22;

S302: the testing instrument 20 receives test parameters of the electronic device 40, generates the test data, and transmits the test data to the data receiving unit 11 of the control device 10;

S303: the data receiving unit 11 transmits the test data to the data analyzing unit 12;

S304: the data analyzing unit 12 analyzes the test data and determines whether the test data are valid; if the test data are within the range of the multiple predetermined test data, the test data are valid, and the procedure goes to step S305; if the test data are not within the range of the multiple predetermined test data, the test data are invalid, and the procedure returns to step S303;

S305: the data analyzing unit 12 transmits the test data which are determined to be valid to the test result display unit 13; the test result display unit 13 displays the test data transmitted by the data analyzing unit 12;

S306: the data analyzing unit 12 transmits and stores the test data which are determined to be valid in the data storage unit 14;

S307: the data analyzing unit 12 compares the test data which are determined to be valid with the multiple predetermined test data and determines whether the testing instrument 20 has completed testing the electronic device 40; when the testing instrument 20 has completed testing the electronic device 40, the procedure goes to step S308; if the testing instrument 20 has not completed testing the electronic device 40, the procedure returns to step S303;

S308: the control device 10 turns off the first I/O interface 15; the testing instrument 20 turns off the second I/O interface 21 and the third I/O interface 22.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. An automatically testing system, comprising:
a control device comprising a first Input/Output (I/O) interface;
a testing instrument comprising a second I/O interface and a third I/O interface; and
a transforming line electrically connected to the control device and the testing instrument; wherein the first I/O interface of the control device is electrically connected to the second I/O interface via the transforming line; the third I/O interface is electrically connected to an electronic device; the testing instrument receives test parameters of the electronic device and generates test data; the testing instrument transmits the test data to the control device through the second I/O interface; the control device is configured for analyzing the test data and determining whether the test data are valid; and the control device displays the test data if the test data are determined to be valid.

2. The automatically testing system of claim 1, wherein the transforming line is configured for transforming and transferring the test data between the first I/O interface and the second I/O interface; the first I/O interface is a Universal Serial Bus (USB) port; and the second I/O interface and the third I/O interface are Digital Visual Interface (DVI) ports.

3. The automatically testing system of claim 1, wherein the control device comprises a data receiving unit and a data analyzing unit; the control device receives the test data through the data receiving unit, and transmits the test data to the data analyzing unit; the data analyzing unit is configured for analyzing the test data and determining whether the test data are valid.

4. The automatically testing system of claim 3, wherein the control device further comprises a test result display unit and a data storage unit; the data analyzing unit transmits the test data which are determined to be valid to the test result display unit; the test result display unit displays the test data transmitted from the data analyzing unit; and the data analyzing unit transmits and stores the test data which determined to be valid in the data storage unit.

5. The automatically testing system of claim 4, wherein the data storage unit stores multiple predetermined test data; the data analyzing unit is configured for comparing the test data with the multiple predetermined test data; when the test data are within a range of the multiple predetermined test data, the test data are determined to be valid; and when the test data are not within the range of the multiple predetermined test data, the test data are determined to be invalid.

6. An automatically testing method, the method comprising:
initializing a first Input/Output (I/O) interface by a control device;
initializing a second I/O interface and a third I/O interface by a testing instrument;
receiving test parameters of an electronic device by the testing instrument, generating test data, and transmitting the test data to the control device by the testing instrument;
receiving the test data and transmitting the test data to a data analyzing unit by the control device;
analyzing the test data and determining whether the test data are valid by the data analyzing unit;
transmitting the test data which are determined to be valid to a test result display unit by the data analyzing unit, and displaying the test data transmitted by the data analyzing unit by the test result display unit;
transmitting and storing the test data which are determined to be valid in a data storage unit by the data analyzing unit; and
determining whether the testing instrument has completed testing the electronic device by the control device, wherein testing the electronic device is determined to have completed when the testing instrument stops transmitting the test data.

7. The automatically testing method of claim 6, comprising storing multiple predetermined test data by the storage unit; and comparing the test data which are determined to be valid with the multiple predetermined test data by the data analyzing unit, wherein when the test data are within a range of the multiple predetermined test data, the test data are determined to be valid; and when the test data are not within the range of the multiple predetermined test data, the test data are determined to be invalid.

8. The automatically testing method of claim 6, the step of determining the testing instrument has completed testing the electronic device comprising comparing the test data which are determined to be valid with the multiple predetermined test data by the data analyzing unit.

9. The automatically testing method of claim 8, further comprising closing the first I/O interface by the control unit, and closing the second I/O interface and the third I/O interface by control device when testing the electronic device is determined to have been completed.
